(19) United States
(12) Patent Application Publication
(10) Pub. No.: US 2011/0004328 A1
(43) Pub. Date: Jan. 6, 2011

(54) CONTROLLER INTERFACE FOR MUSICAL APPLICATIONS ON HANDHELD COMPUTING DEVICES

(75) Inventors: Glen T. Darcey, Brubank, CA (US); Peter J. Goodliffe, Cambridge (GB); Brian R. Shim, Providence, RI (US); John A. Souppa, Ashland, MA (US); Jan C. Wissmuller, Cumberland, RI (US)

Correspondence Address: BARLOW, JOSEPHS & HOLMES, LTD., 101 DYER STREET, 5TH FLOOR, PROVIDENCE, RI, 02903, US

(73) Assignee: NUMARK INDUSTRIES, LP, Fort Lauderdale, FL (US)

(21) Appl. No.: 12/828,418

(22) Filed: Jul. 1, 2010

Related U.S. Application Data
(60) Provisional application No. 61/222,252, filed on Jul. 1, 2009.
(60) Provisional application No. 61/311,300, filed on Mar. 6, 2010.

(51) Int. Cl. G06F 17/00

(52) U.S. Cl. 700/90

(57) ABSTRACT

A controller for a handheld computing device having a music-oriented program operating thereon is disclosed. The controller includes a control surface configured and arranged to be manipulated by an operator to generate a control input. Further included is a circuit configured and arranged to detect the control input generated from the control surface and transmit the control input received from the control surface to the music-oriented program operating on the handheld computing device.

The present patent document claims priority to earlier filed U.S. Provisional Patent Application Ser. Nos. 61/222,252, filed on Jul. 1, 2009, and 61/311,300, filed on Mar. 6, 2010, the entire contents of which are incorporated by reference.

### BACKGROUND OF THE INVENTION

1. Field of the Invention

The present patent document relates generally to handheld computing devices and more particularly to a music-oriented controller for a handheld computing device.

2. Background of the Related Art

Handheld computing devices, such as the iPhone and iPod Touch brand handheld computing devices manufactured by Apple, Inc., are becoming popular platforms for music creation applications since the processing power of these handheld computing devices have increased significantly. These music creation applications may include on-screen keyboards for playing piano and synthesizer-type sounds, and on-screen drums for playing drum sounds, among others.

However, these applications lack both an ergonomic and a music-oriented way for users to enter note and controller data so that users can record or perform their music.

Referring to FIG. 1, a prior art view of a keyboard application is shown on a handheld computing device at 10. However, the handheld computing device 10 has a control surface 12 that is a small touch sensitive screen, which makes it difficult to perform many types of music. In the virtual keyboard example, the virtual keys 14 are tiny and unplayable without striking unintended virtual keys 14.

The virtual keys 14 may be made larger, however, as shown in FIG. 2. Even though this solution enables more accurate striking of the virtual keys 14, there are now so few virtual keys 14 that the range of melodies and chords that can be played is extremely limited.

In addition to the limited size of the control surfaces 12, the control surfaces 12 also suffer from the disadvantage of lacking velocity sensitivity (i.e. tapping soft and hard produces the same volume of sound). This disadvantage affects drum simulators as shown in FIGS. 3 and 4, as well as keyboard simulators shown earlier in FIGS. 1 and 2.

Therefore, there is a perceived need for a device that enables a user to comfortably and conveniently enter note and controller data to a handheld computing device 10. There is also a perceived need for a device that enables a handheld computing device 10 to detect velocity of strikes against a control surface 12.

There is prior art regarding devices which connect to a handheld computing devices 10, such as iPod and/or iPhone brand devices, that enable recording or make it easier to play back music on the handheld computing device 10.

For example, the Alesis Pro Track has an iPod dock. The Pro Track enables an iPod or iPhone brand device to record music when it is docked to it. It has professional

Another example is the Alesis iMultimix 8USB brand controller device. This is a mixer with iPod brand device dock which also enables recording. There are controls to replicate the iPod brand device controls, along with controls for the analog signal.

However, these prior art devices suffer from the disadvantage in that, although they enable input control of the handheld computing device 10, they lack the ability to control and communicate with third party applications running on the handheld computing device 10. Specifically, these prior art devices cannot communicate with applications directly, but can only replicate simple primitive control inputs that correspond to the interface controls on the handheld computing device 10. Accordingly, there is a perceived need for a device to permit direct communication and control of third party applications on a handheld computing device 10.

### SUMMARY OF THE INVENTION

The present invention solves the problems of the prior art by providing a device having a control surface including a dock or wireless connection for a handheld computing devices that further is configured and arranged for direct communication with a program application running on the handheld computing device.

Accordingly, among the objects of the present invention is the provision for a more ergonomic, playable, and musically inspiring control surface for a handheld computing device, such as an iPhone or iPod touch.

Another object of the present invention is the provision for a control surface that can interface and communicate with a music program application running on a handheld computing device.

Another object of the present invention is the provision for a control surface that includes physical wheels, sliders, knobs, piano style keys, drum pads, touch strips, joy sticks, and XY-axis pads.

Another object of the present invention is the provision for a control surface that includes larger controls that are more easily manipulated than the control surface of a handheld computing device.

Another object of the present invention is the provision for a greater number of controls and control inputs than the handheld computing device contains.

Another object of the present invention is the provision for a control surface that includes velocity sensitivity.

Yet, another object of the present invention is the provision for a control surface that permits tactile response.

Yet, another object of the present invention is the provision for a control surface that detects differences in pressure.

Another provision of the present invention is the provision for a standard output methods for the professional musician, such as professional I/O jacks, XLR jacks, 1/4″ jacks, and RCA jacks.

### BRIEF DESCRIPTION OF THE DRAWINGS

These and other features, aspects, and advantages of the present invention will become better understood with reference to the following description, appended claims, and accompanying drawings where:

FIG. 1 is a prior art view of a handheld computing device with a keyboard application running thereon with a full view of the keys of the keyboard;

FIG. 2 is a prior art view of a handheld computing device with a keyboard application running thereon with a magnified view of the keys of the keyboard;

FIG. 4 is a prior art view of a handheld computing device having a drum pad application running thereon;

FIG. 5 is a prior art view of a handheld computing device having another drum pad application running thereon;

FIG. 6A is a rear view of an alternative embodiment of the music-oriented controller of the present invention;

FIG. 6B is a top view of an alternative embodiment of the music-oriented controller of the present invention;

FIG. 7 is a block diagram of an embodiment of an electrical circuit for a music-oriented controller of the present invention;

FIG. 8 is a block diagram of an alternative embodiment of an electrical circuit for a music-oriented controller of the present invention;

FIG. 9 is a perspective view of a second alternative embodiment of the music-oriented controller of the present invention;

FIG. 10 is an exploded view of a second alternative embodiment of the music-oriented controller of the present invention; and

FIG. 11 is a block diagram of a second alternative embodiment of an electrical circuit for a music-oriented controller of the present invention.

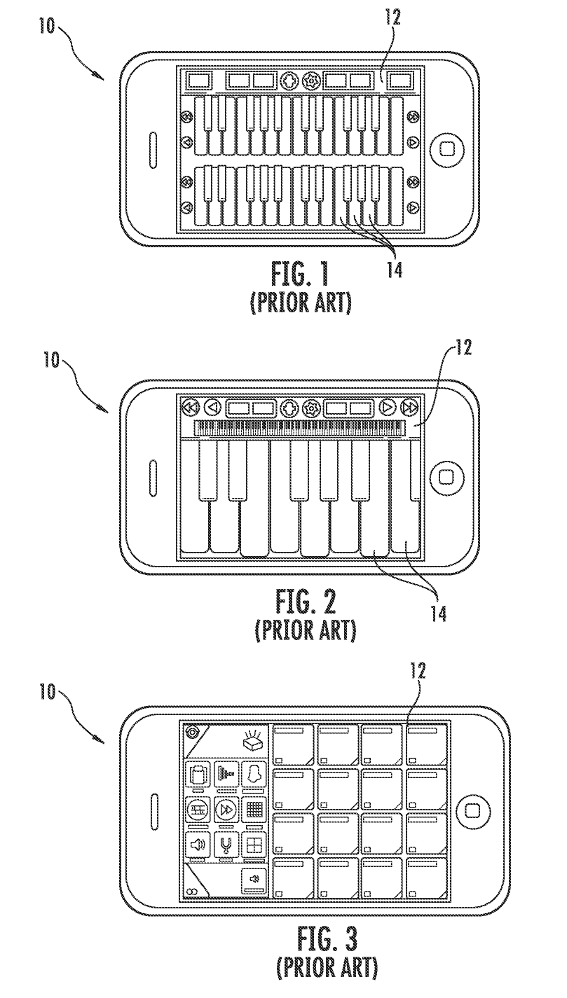

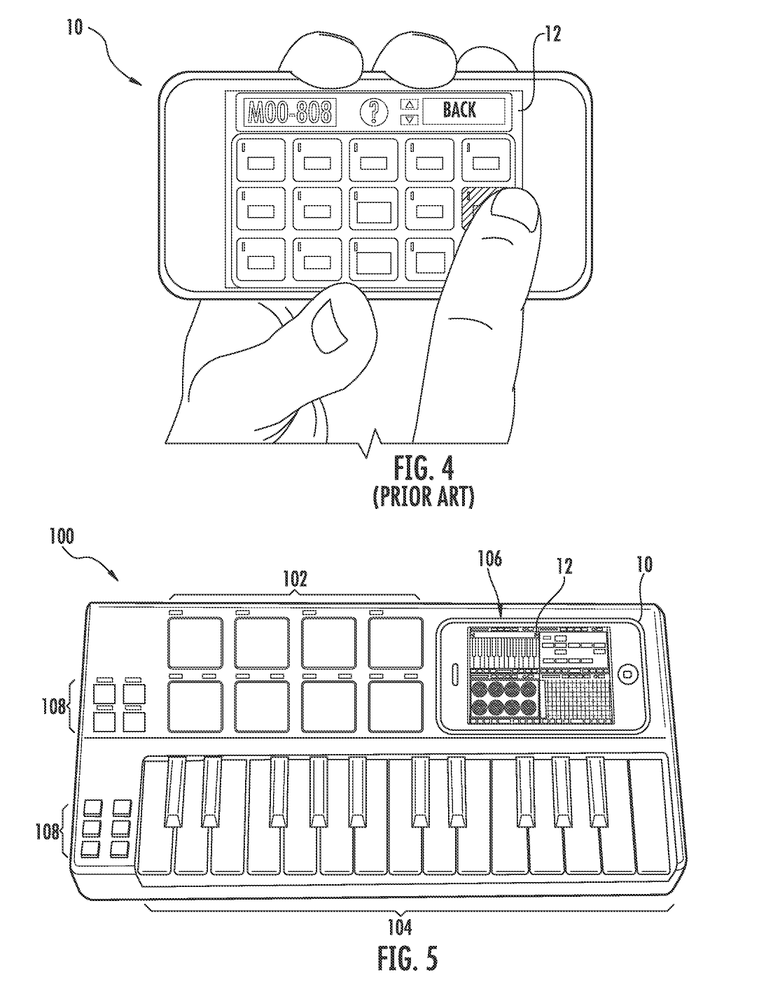

### DESCRIPTION OF THE PREFERRED EMBODIMENT

Referring now to FIG. 5, an embodiment of the music-oriented controller of the present invention is shown generally at 100. The controller includes a number of velocity sensitive control surfaces. In particular, keyboard keys 102 and drum pads 104 may be included. The controller 100 also includes a dock 106 configured to permit a handheld computing device 10 to interface therein. As can be appreciated, the use of velocity sensitive control surfaces allows the controller 100 to detect the force with which the control surfaces are struck, thus allowing the controller 100 to send appropriate note and controller input data to the handheld computing device 10. Also the controller 100 may include various analog audio controls 108 such as volume, equalizers and special effects that may manipulate the control input of the keyboard keys 102 and drum pads 104 as they are struck.

In addition to various analog audio controls 108, the controller 100 may further include a number of alphanumeric keys (not shown). The alphanumeric keys may be further arranged in a “QWERTY” keyboard arrangement.

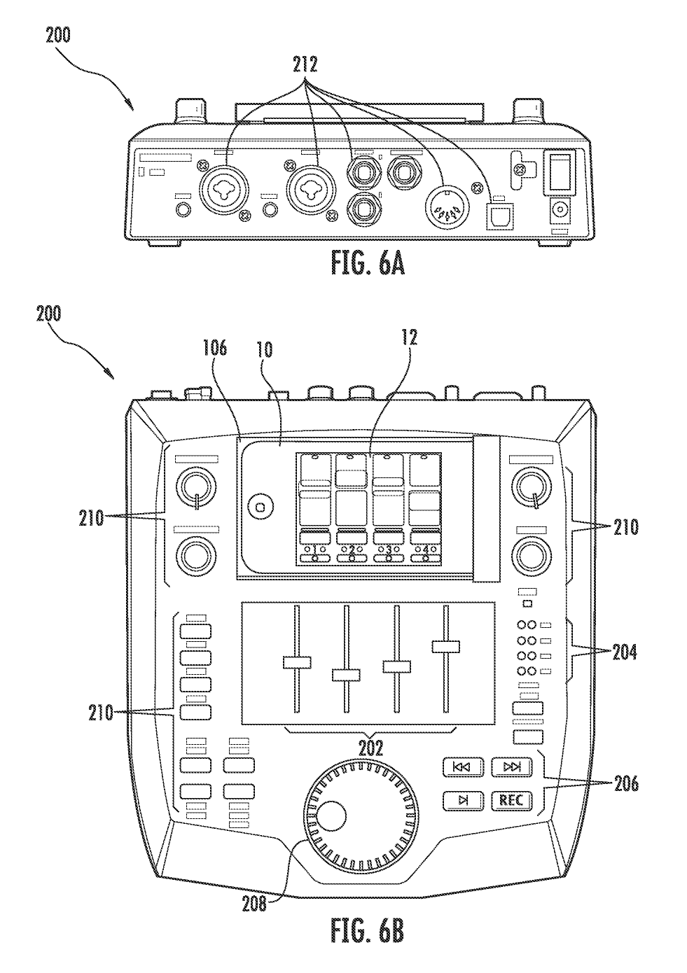

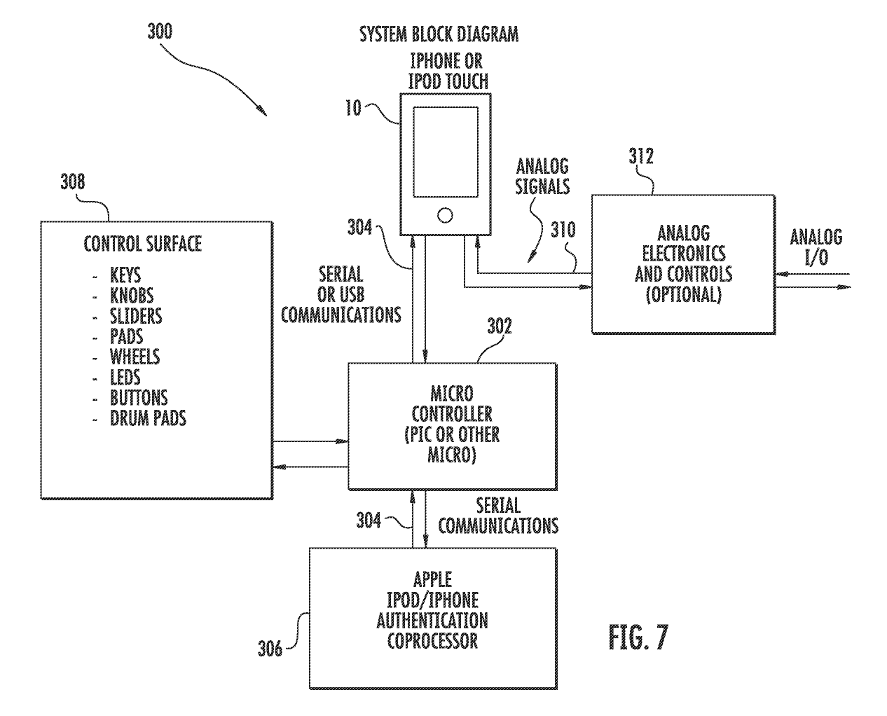

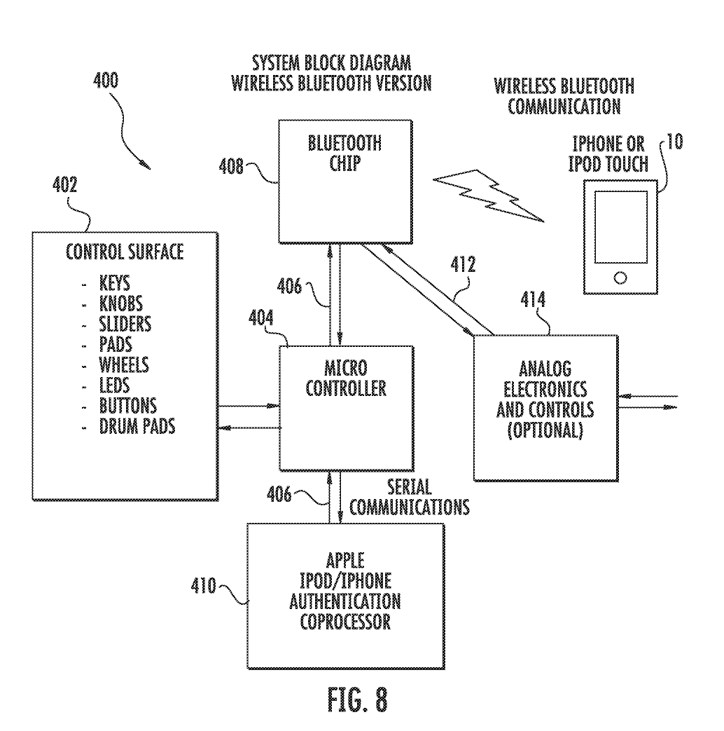

Referring now to FIGS. 6A and 6B, another embodiment of music-oriented controller of the present invention is shown at 200. The alternative embodiment 200 controller includes a dock 106 configured to permit a handheld computing device 10 to interface therein. The alternative controller 200 also includes control surfaces such as sliders 202. In addition to sliders 202, the controller may include level meters 204, transport controls 206 for the handheld computing device, a jog wheel 208 and various analog audio controls 210, such as volume, equalizers and other special effects. The controller may include I/O jacks 212 such as professional I/O jacks, XLR jacks, 1/4″ jacks, and RCA jacks.

Referring now to FIG. 7, a block diagram of an electronic circuit for the controller is shown at 300. The circuit 300 includes a microcontroller 302. The microcontroller 302 communicates with the handheld computing device 10 via a serial interface 304 (such as USB). In the instance where the handheld computing device 10 is an Apple brand iPod or iPhone device, the microcontroller 302 also communicates serially with an authentication chip 306, which is necessary to enable recording and other functions in Apple brand devices.

The microcontroller 302 also detects and interprets musician interaction with the velocity sensitive control surfaces and other control surfaces 308. For instance, the microcontroller 302 performs key and control scanning to detect button presses, key presses, drum pad hits, knob turns, and the like. The microcontroller 302 interprets these actions and sends the appropriate command, or control input, to the handheld computing device 10 via the serial interface 304. As can be appreciated, the use of velocity sensitive control surfaces enable the microcontroller 302 to send note data that includes the force with which the control surface was struck, thus providing a greater range of recordable music.

The handheld computing device 10 may also send commands back to the microcontroller 302. For example, the handheld computing device 10 could send a command to light up an LED on the controller.

Because handheld computing devices 10 generally have analog inputs and outputs 310 for music, these can be utilized for recording and playback. The controller may also include additional analog circuitry 312 for gain, equalizer and other functions, as well as professional industry-standard audio jacks.

Referring now to FIG. 8, a block diagram of another embodiment 400 of the electronic circuit of the controller may utilize wireless communications, such as Bluetooth, to communicate with the handheld computing device.

In this embodiment, the handheld computing device 10 is not physically docked to the controller. Instead, the controller communicates with the handheld computing device 10 wirelessly. Specifically, control inputs from the control surfaces 402 are received by a microcontroller 404. The microcontroller 404 transmits the control inputs serially 406 to the wireless transmitter 406, which in turn transmits the control inputs to the handheld computing device 10.

As can be understood, the handheld computing device can still be authenticated with am authentication chip 410 and also transmit analog input and output 412 through the wireless transmitter 406. Additional analog circuitry 414 for gain, equalizer and other functions, as well as professional industry-standard audio jacks may be included to further process the analog input and output 412 from the handheld computing device 10.

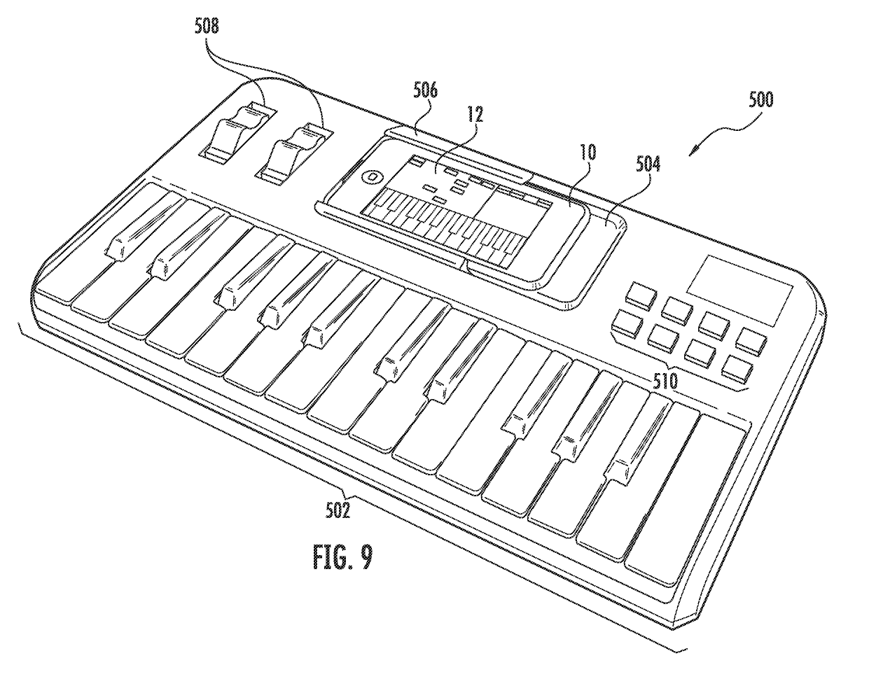

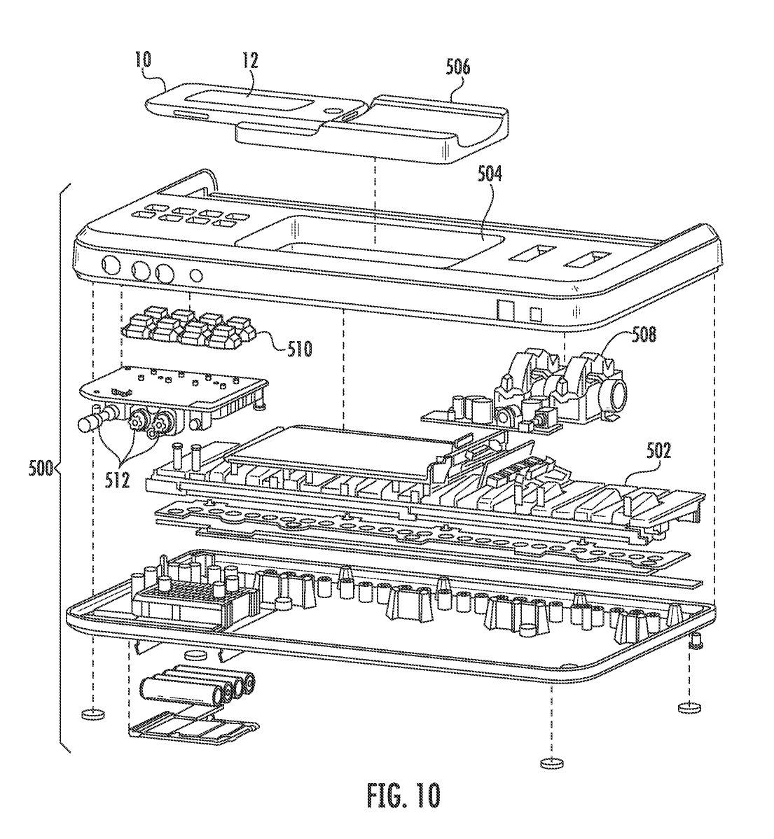

Referring now to FIGS. 9 and 10, yet another embodiment of the controller of the present invention is shown generally at 500. The controller 500 includes a number of velocity sensitive control surfaces. In particular, two-octave velocity sensitive keyboard keys 502 may be included. The controller 500 also includes a dock 504 configured to permit a handheld computing device 10 to interface therein. An additional insert 506 may be included to cradle the handheld computing device 10. As can be appreciated, the use of velocity sensitive keyboard keys 502 permit the controller 500 to detect the force with which the keys 502 are struck, thus allowing the controller 500 to send appropriate note and control input data to the handheld computing device 10.

The controller 500 may include pitch modulation wheels 508 to manipulate the control input of the keyboard keys 502 when they are struck.

Also the controller 500 may include various analog audio controls 510 such as volume, equalizers and special effects that may further manipulate the control input of the keyboard keys 502.

The controller 500 may include I/O jacks 512 such as professional I/O jacks, XLR jacks, 1/4″ jacks, and RCA jacks like the other embodiments 100, 200 described above.

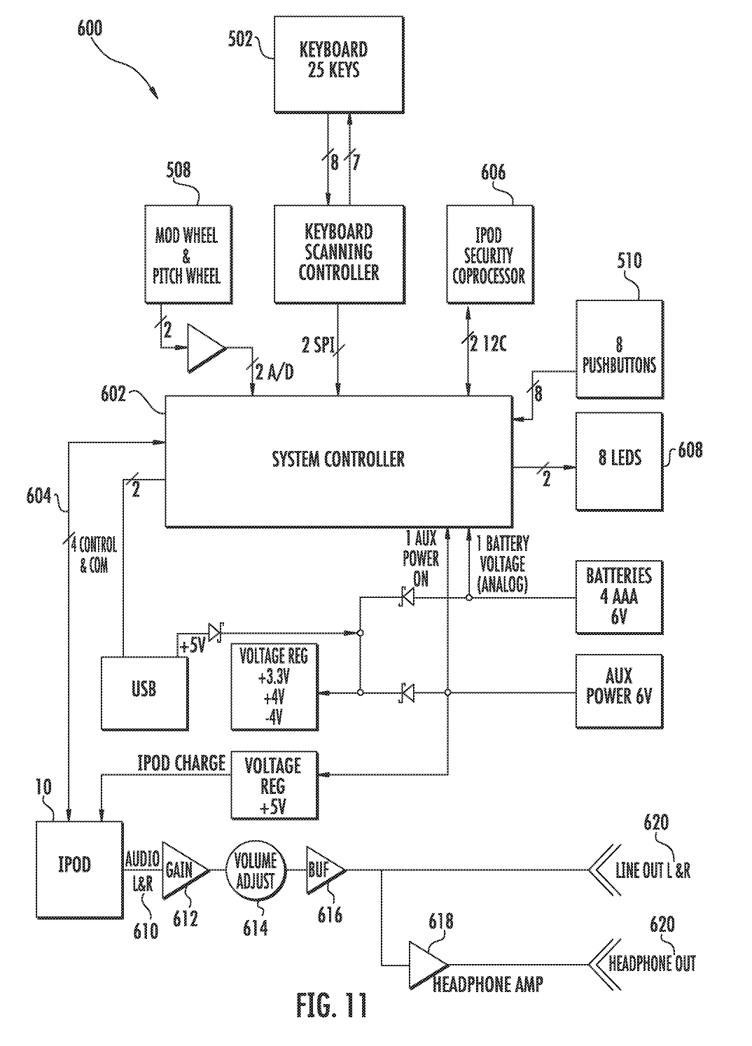

Control inputs may be formatted as MIDI messages as is known in the art. This allows the controller 500 to control either a program operating on the handheld computing device 10 or a program operating on personal computer. MIDI messages can also be sent from the personal computer through the controller 500 of the present invention to a program operating on the handheld computing device 10. LEDs 608 (identified in FIG. 11) on the controller 500 may also be controlled through MIDI messages transmitted by the handheld computing device 10.

The control input generated by the control surfaces may also be transmitted to the handheld computing device 10 via a unique messaging protocol. The control input may be formatted into a packet which contains a marker designating the start of the packet, a command or response code, a length of the payload, a payload data, and a checksum. The program running on the handheld computing device 10 interprets the control input packet into note data that describes the note played, velocity of the strike, and length of the strike against the control surface in order to interpret the manipulation of the control surface into an audible sound that is transmitted out the analog audio outputs on the handheld computing device and audio output jacks 512.

Referring now to FIG. 11, a block diagram of another embodiment of an electronic circuit for the controller is shown at 600. The circuit 600 includes a microcontroller 602 (or alternatively a system controller). The microcontroller 602 communicates with the handheld computing device 10 via a serial interface 604 (such as USB). In the instance where the handheld computing device 10 is an Apple brand iPod or iPhone device, the microcontroller 602 also communicates serially with an authentication chip 606, which is necessary to enable recording and other functions in Apple brand devices.

The microcontroller 602 also detects and interprets musician interaction with the velocity sensitive control surfaces and other control surfaces, such as the keyboard keys 502. For instance, the microcontroller 602 performs key and control scanning to detect button presses of various buttons 510, activation of the pitch wheels 508, and the like. The microcontroller 602 interprets these actions and sends the appropriate command, or control input, to the handheld computing device 10 via the serial interface 604. As can be appreciated, the use of velocity sensitive control surfaces enable the microcontroller 602 to send note data that includes the force with which the control surface was struck, thus providing a greater range of recordable music.

The handheld computing device 10 may also send commands back to the microcontroller 602. For example, the handheld computing device 10 could send a command to light up an LED 608, such as backlights on the buttons, on the controller 500.

Because handheld computing devices 10 generally have analog inputs and outputs 610 for music, these can be utilized for recording and playback. The controller may also include additional analog circuitry for gain 612, equalizer and other functions, such as gain 612, volume 614, buffering 616, and amplifying 618, as well as professional industry-standard audio jacks 620.

Therefore, it can be seen that the present invention provides a unique solution to the problem of providing a music-oriented controller for a handheld computing device that includes larger, velocity sensitive keys and various other music controls that are desired by musicians.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A controller for a handheld computing device having a music-oriented program operating thereon, the controller comprising:
a control surface configured and arranged to be manipulated by an operator to generate a control input; and
a circuit configured and arranged to detect the control input generated from the control surface and transmit the control input received from the control surface to a music-oriented program operating on a handheld computing device.

2. The device of claim 1 wherein the control surface is selected from the group consisting essentially of wheels, sliders, knobs, piano-style keys, drum pads, touch strips, joy sticks, and XY-axis pads.

3. The device of claim 1, wherein the control surface is sized and dimensioned for ergonomic activation by an operator.

4. The device of claim 1, further comprising a plurality of control surfaces.

5. The device of claim 1, wherein the control surface is further configured and arranged to detect the velocity of a strike against the control surface and transmit the velocity of the strike as part of the control input.

6. The device of claim 1, wherein the control surface is further configured and arranged to provide the operator a tactile response to manipulating the control surface.

7. The device of claim 1, wherein the control surface is further configured and arranged to detect differences in tactile pressure made against the control surface and communicate the difference in tactile pressure as part of the control input.

8. The device of claim 1, wherein the circuit is further configured and arranged to transmit the control input generated by the control surface to the handheld computing device wirelessly.

9. The device of claim 1, wherein the circuit is further configured and arranged to transmit the control input generated by the control surface to the handheld computing device through a serial interface connection.

10. The device of claim 1, further comprising at least one input and output connector connected to the circuit.

11. The device of claim 1, wherein the control input is formatted as a packet including a marker designating the start of the packet, a command or response code, a length of the payload, a payload data, and a checksum.

12. The device of claim 1, wherein the control input is formatted as a MIDI message.
